(19) United States
(12) Patent Application Publication
(10) Pub. No.: US 2008/0317120 A1
(43) Pub. Date: Dec. 25, 2008

(54) Method and System for MPEG2 Progressive/Interlace Type Detection

(76) Inventors: David Drezner, Raanana (IL); Yehuda Mittelman, Yokneam (IL)

Correspondence Address: MCANDREWS HELD & MALLOY, LTD, 500 WEST MADISON STREET, SUITE 3400, CHICAGO, IL, 60661, US

(21) Appl. No.: 11/768,000

(22) Filed: Jun. 25, 2007

(51) Int. Cl. H04N 7/26; H04B 1/66; H04N 11/02; H04N 7/12

(52) U.S. Cl. 375/240.02; 375/E07.127

(57) ABSTRACT

Methods and systems for MPEG2 progressive/interlace type detection are disclosed. Aspects of one method may include determining whether video data may comprise interlaced or progressive video data type, and use appropriate DCT coefficients scanning method for that video data type. Video data type may be determined by determining a number of interlaced macroblocks (IMs), for example, in a 60 frame macrocluster. This may comprise comparing field and frame variances for each macroblock in the original unencoded frame. The number of IMs may then be processed to generate a number of IMs in the macrocluster. The number of IMs in the macrocluster may be processed to determine the video data type. If, for example, three consecutive macroclusters are considered to be interlaced, then an appropriate pixel scanning method may be used for encoding. Similarly, if three consecutive macroclusters are considered to be progressive, then another appropriate pixel scanning method may be used for encoding.

### CROSS-REFERENCE TO RELATED APPLICATIONS/INCORPORATION BY REFERENCE

[Not Applicable.]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to signal processing. More specifically, certain embodiments of the invention relate to a method and system for MPEG2 progressive/interlace type detection.

### BACKGROUND OF THE INVENTION

In video system applications, a picture is displayed on a television or a computer screen by scanning an electrical signal horizontally across the screen one line at a time using a scanning circuit. The amplitude of the signal at any one point on the line represents the brightness level at that point on the screen. When a horizontal line scan is completed, the scanning circuit is notified to retrace to the left edge of the screen and start scanning the next line provided by the electrical signal. Starting at the top of the screen, all the lines to be displayed are scanned by the scanning circuit in this manner. A frame contains all the elements of a picture. The frame contains the information of the lines that make up the image or picture and the associated synchronization signals that allow the scanning circuit to trace the lines from left to right and from top to bottom.

There are two widely used types of picture or image scanning in a video system. In one type, the scanning may be interlaced, while in the other type, the scanning may be progressive. Interlaced video, which may be used for analog television and some HDTV, for example, occurs when each frame is divided into two separate sub-pictures or fields. These fields may have originated at the same time or at subsequent time instances. The interlaced picture may be produced by first scanning the horizontal lines for the first field and then retracing to the top of the screen and then scanning the horizontal lines for the second field. The progressive, or non-interlaced, video, which may be used for DVDs and some HDTV, for example, may be produced by scanning all of the horizontal lines of a frame in one pass from top to bottom.

When video programs are compressed, for example, for transmission via the Internet, a particular algorithm used for compression may be more efficient depending on whether the scanning is interlaced or progressive. However, many video systems may use the same compression algorithm regardless of whether the video is interlaced or progressive. Accordingly, the compressed video, or encoded video, may not be compressed as efficiently as if a compression algorithm optimized for interlaced video is used for interlaced scan video data, or if a compression algorithm suitable for progressive scan is used for progressive scan video data.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for MPEG2 progressive/interlace type detection, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is an exemplary diagram of a portion of a video system, which may be utilized in connection with an embodiment of the invention.

FIG. 1A is an exemplary diagram of an MPEG intra coding scheme, which may be utilized in connection with an embodiment of the invention.

FIG. 1B is an exemplary diagram of an MPEG inter coding scheme, which may be utilized in connection with an embodiment of the invention.

FIG. 2A is an exemplary diagram illustrating a pixel block, which may be utilized in connection with an embodiment of the invention.

FIG. 2B is an exemplary diagram illustrating zig-zag scan of a pixel block, which may be utilized in connection with an embodiment of the invention.

FIG. 2C is an exemplary diagram illustrating alternate scan of a pixel block, which may be utilized in connection with an embodiment of the invention.

FIG. 3 is an exemplary flow diagram for determining whether video data is interlaced or progressive, in accordance with an embodiment of the invention.

FIG. 4A is an exemplary flow diagram for determining whether macroblock of video data is interlaced or progressive, in accordance with an embodiment of the invention.

FIG. 4B is an exemplary diagram illustrating a macroblock of video data for calculating frame variance, in accordance with an embodiment of the invention.

FIG. 4C is an exemplary diagram illustrating a macroblock of video data for calculating field variance, in accordance with an embodiment of the invention.

FIG. 5 is an exemplary flow diagram for calculating an appropriate number of interlaced video blocks in a determined number of frames, in accordance with an embodiment of the invention.

FIG. 6 is an exemplary flow diagram for determining whether video data is interlaced or progressive, in accordance with an embodiment of the invention.

### DETAILED DESCRIPTION OF THE INVENTION

Certain embodiments of the invention may be found in a method and system for MPEG2 progressive/interlace type detection. Aspects of the method may comprise adaptively changing an encoding algorithm based on whether video data may be determined to be interlaced type or progressive type. This may comprise, for example, encoding at least a portion of the video data using a zigzag scan when the video data is determined to be progressive type, and encoding at least a portion of the video data using alternate scan when the video data is determined to be interlaced type. When the video data is determined to be progressive type, a top-field first cadence or bottom-field first cadence may also be determined, if applicable.

The video data may be determined to be interlaced type or progressive type by determining a number of interlaced macroblocks in each frame in a cluster of frames. A field variance and frame variance may be calculated for each macroblock using the pixels from the original unencoded frame, and the field variance may be subtracted from the frame variance. If the difference is larger than a threshold value, the macroblock may be considered to be an interlaced macroblock. Otherwise, the macroblock may be considered to be progressive macroblock. The number of interlaced macroblocks for a frame may be calculated for each frame in a cluster, and the smallest of the four numbers may be selected as a number of the interlaced macroblocks corresponding to the cluster. The number of interlaced macroblocks in a cluster may be added to a total of interlaced macroblocks in a macrocluster. The total number of interlaced macroblocks in a macrocluster may be compared to an interlace threshold and/or a progressive threshold, where the two thresholds may be different.

If the total number of interlaced macroblocks in a macrocluster is greater than the interlaced threshold, then the macrocluster may be considered to be interlaced data. When a plurality of consecutive macroclusters, for example, three consecutive macroclusters, are considered to be interlaced data, then the video data may be considered to be interlaced and alternate scan may be used for encoding. Similarly, if the total number of interlaced macroblocks in a macrocluster is less than the progressive threshold, then the macrocluster may be considered to be progressive data. When a plurality of consecutive macroclusters, for example, three consecutive macroclusters, are considered to be progressive data, then the video data may be considered to be progressive and zig-zag scan may be used for encoding. Although the field variance and frame variance may have been calculated using the original unencoded picture, the scan method decision may apply to the scan method of the discrete cosine transform (DCT) coefficients of residual pixels.

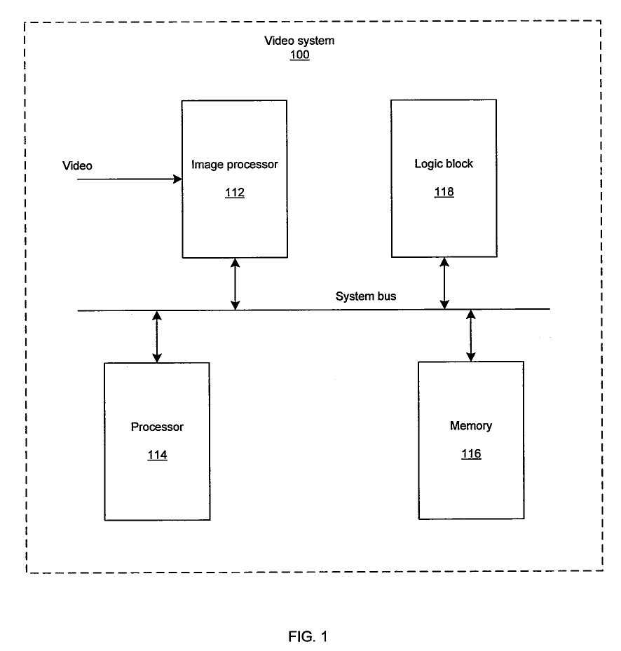

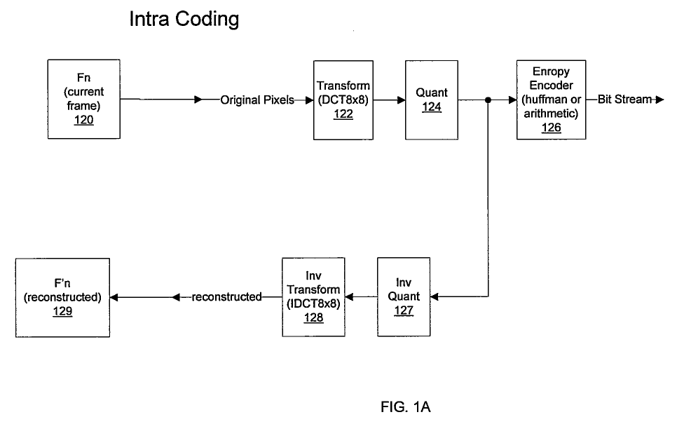

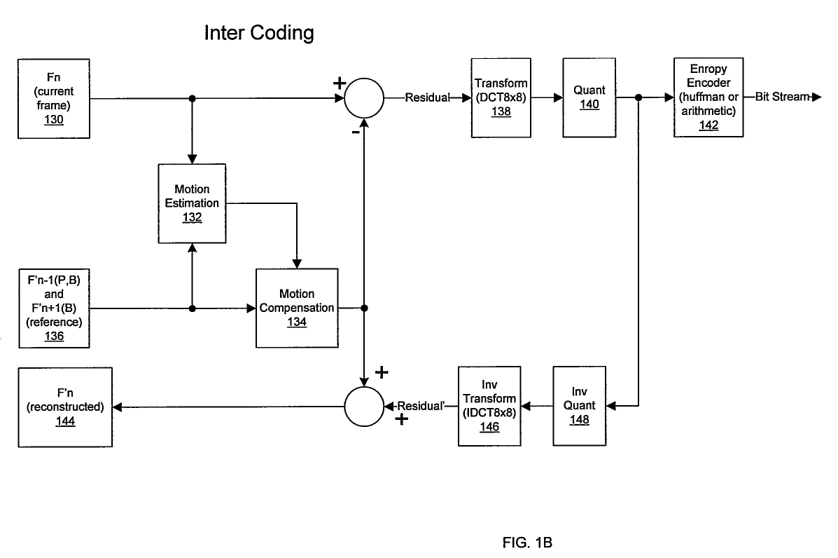

FIG. 1 is an exemplary diagram of a portion of a video system, which may be utilized in connection with an embodiment of the invention. Referring to FIG. 1, there is shown a video system 100. The video system 100 may comprise an image processor 112, a processor 114, a memory block 116, and a logic block 118. The image processor 112 may comprise suitable circuitry and/or logic that may enable processing of video data. The video data may be processed, for example, for display on a monitor, or encoded for transfer to another device. For example, the video system 100 may be a part of a computer system that may compress the video data in video files for transfer via the Internet. Similarly, the video system 100 may encode video for transfer to, for example, a set-top box, which may then decode the encoded video for display by a television set.

The processor 114 may determine the mode of operation of various portions of the video system 100. For example, the processor 114 may configure data registers in the image processor block 112 to allow direct memory access (DMA) transfers of video data to the memory block 116. The processor may also communicate instructions to the image sensor 110 to initiate capturing of images. The memory block 116 may be used to store image data that may be processed and communicated by the image processor 112. The memory block 116 may also be used for storing code and/or data that may be used by the processor 114. The memory block 116 may also be used to store data for other functionalities of the video system 100. For example, the memory block 114 may store data corresponding to voice communication. The logic block 118 may comprise suitable logic and/or code that may be used for video processing. For example, the logic block 118 may comprise a state machine that may enable determination of whether video data type may be interlaced type or progressive type.

In operation, an MPEG2 video encoder, which may be, for example, part of the image processor 112, may encode a sequence of pictures in two complementary methods: intra coding and inter coding. FIG. 1A illustrates an exemplary intra coding and FIG. 1B illustrates exemplary inter coding. An embodiment of the invention may encode a plurality of frames using inter coding for each frame encoded using intra coding.

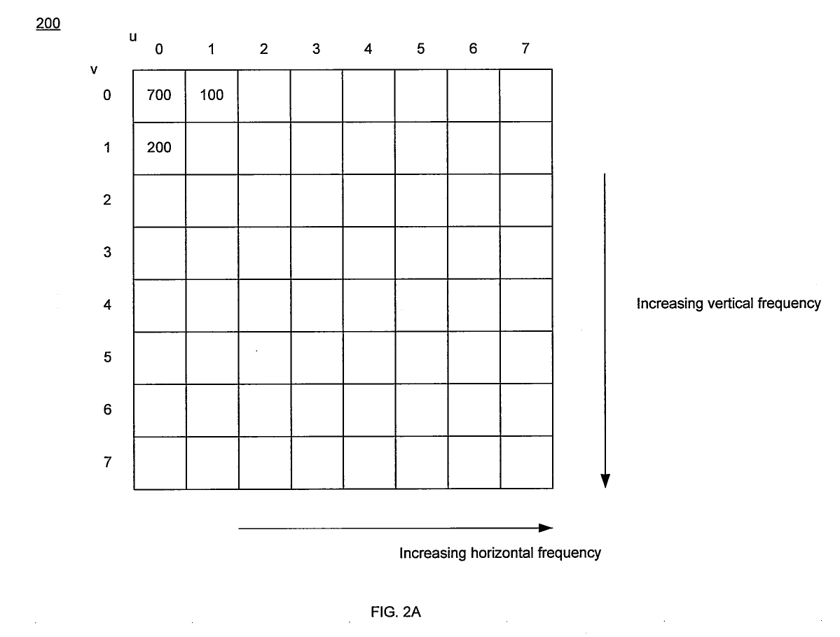

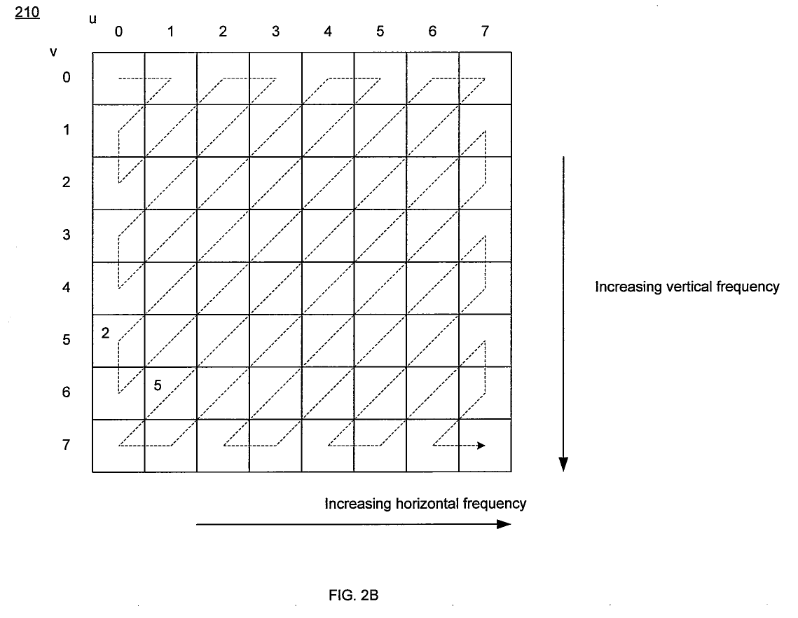

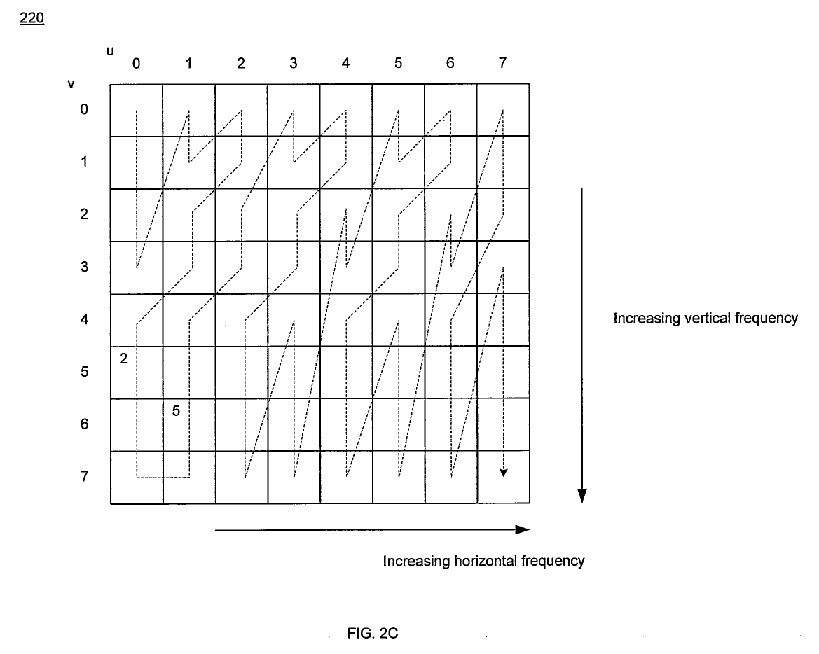

The image processor block 112 may perform a discrete cosine transform (DCT) to video data in blocks of 8×8 pixels. The video data may be part of a video file, for example. The result may comprise DCT coefficients for the 8×8 block. The top-left hand coefficient may be the DCT coefficient for a DC value, and the remaining coefficients may comprise AC values where the frequencies may increase to the left and to the downward direction. This is illustrated in FIG. 2A.

The DCT coefficients may be compressed to generate smaller video files. For efficient compression, it may be desirable to scan the DCT coefficients in the blocks such that as many zeros are next to each other as possible. Various scanning algorithms may be used to optimize the sequential number of zeros. Exemplary scanning algorithms that may be used are zig-zag scan and alternate scan. FIGS. 2B and 2C illustrate these algorithms in more detail.

FIG. 1A is an exemplary diagram of an MPEG intra coding scheme, which may be utilized in connection with an embodiment of the invention. Referring to FIG. 1A, there is shown buffers 120 and 129, a DCT transform block 122, a quantizer block 124, an entropy encoder block 126, an inverse quantizer block 127, and an inverse transform block 128. The buffer 120 may hold original pixels of a current picture and the DCT transform block 122 may perform DCT transform of the original pixels. The DCT transform block 122 may generate DCT coefficients, which may be communicated to the quantizer block 124. The quantized coefficients generated by the quantizer block 124 may then be scanned using zig-zag or alternate scan by the entropy encoder block 126.

The quantized coefficients from the quantizer block 124 may be processed by the inverse quantizer block 127, then processed by the inverse DCT transform block 128 to reconstruct pixels from the original frame. The reconstructed pixels from the inverse transform block 128 may be stored, for example, in the buffer 129. The reconstructed pixels may be used, for example, for processing subsequent video frames.

FIG. 1B is an exemplary diagram of an MPEG inter coding scheme, which may be utilized in connection with an embodiment of the invention. Referring to FIG. 1B, there is shown buffers 130, 136, and 144, a motion estimation block 132, a motion compensation block 134, a DCT transform block 138, a quantizer block 140, an entropy encoder block 142, an inverse quantizer block 148, and an inverse transform block 146.

The buffer 130 may hold the original pixels of the current frame and the buffer 136 may hold reconstructed pixels of previous frames. An encoding method from, for example, MPEG standard, may use the motion estimation block 132 to process a block of 16×16 pixels in the buffer 130 and a corresponding block of pixels and to find a motion vector for the block of 16×16 pixels. The motion vector may be communicated to the motion compensation block 134, which may use the motion vector to generate a motion compensated block of 16×16 pixels from the reconstructed pixels stored in the buffer 136. The motion compensated block of 16×16 pixels may be subtracted from the original pixels from the buffer 130, and the result may be referred to as residual pixels.

The residual pixels may be DCT transformed by DCT transform block 138, and the resulting DCT coefficients may be quantized by the quantizer block 140. The quantized coefficients fro the quantizer block 140 may be communicated to the entropy encoder 142 and the inverse quantizer block 148. The entropy encoder block 142 may scan the quantized coefficients in zig-zag scan order or alternate scan order.

The quantized coefficients may be processed by the inverse quantizer block 148 and then by the inverse DCT transform block 146 to generate reconstructed residual pixels. The reconstructed residual pixels may then be added to the motion compensated block of 16×16 pixels from the motion compensation block 134 to generate reconstructed pixels, which may be stored in the buffer 144. The reconstructed pixels may be used, for example, to process subsequent video frames.

FIG. 2A is an exemplary diagram illustrating a pixel block, which may be utilized in connection with an embodiment of the invention. Referring to FIG. 2A there is shown an exemplary DCT coefficient array 200 of size 8×8. The DCT coefficient array 200 may be generated from video data that may correspond to a pixel block of 8×8. The following exemplary equation may be used to generate the DCT coefficient array:

$$F ( u , v ) = \frac{{C}_{u}}{2} \frac{{C}_{v}}{2} {\sum }_{y = 0}^{7} {\sum }_{x = 0}^{7} f ( x , y ) cos [ \frac{( 2 x + 1 ) u π}{16} ] cos [ \frac{( 2 y + 1 ) v π}{16} ] \qquad ( 1 )$$

where Cᵤ=1/\sqrt{2} if u=0 and Cᵤ=1 if u>0, Cᵥ=1/\sqrt{2} if u=0 and Cᵥ=1 if v>0, and f(x,y) is the brightness of the pixel position (x,y) or the residual value at position (x,y).

The original pixels may be recreated from the DCT coefficient array 200 by using the following exemplary equation for inverse DCT:

$$f ( x , y ) = {\sum }_{u = 0}^{7} {\sum }_{v = 0}^{7} F ( u , v ) cos [ \frac{( 2 x + 1 ) u π}{16} ] cos [ \frac{( 2 y + 1 ) v π}{16} ] . \qquad ( 2 )$$

The resulting pixel values may be lossless if the transformed values of the DCT coefficient array 200 have not been quantized. If they have been quantized, the recreated pixel values may be different from the original pixel values. However, various encoding schemes may use different quantization values for different pixel blocks to reduce visible error due to quantization. The quantization value used, for example, may depend on a position of the pixel block.

For the DCT coefficient array 200, a DC value of 700 may be at F(0,0), and AC values may be 100 at F(0,1) and 200 at F(1,0). The remaining DCT coefficients may be, for example, zeros. Accordingly, the DCT coefficient array 200 may be encoded by specifying the values at F(0,0), F(0,1), and F(0,2), followed by an end-of-block (EOB) symbol. The particular method of arranging the coefficients may depend on a scanning algorithm used. For example, a zig-zag scan or alternate scan may be used. These scanning algorithms are described in more detail in FIGS. 2B and 2C.

FIG. 2B is an exemplary diagram illustrating zig-zag scan of a pixel block, which may be utilized in connection with an embodiment of the invention. Referring to FIG. 2B there is shown an exemplary DCT coefficient array 210 of size 8×8, where F(0,5) has a coefficient value of 2 and F(1,6) has a coefficient value of 5. The remaining coefficients may be zeros. Zig-zag scanning of the coefficients in the DCT coefficient array 210 may scan F(0,0), then F(1,0), then F(0,1). The next coefficients scanned may be F(0,2), then F(1,1), then F(2,0). The next coefficients scanned may be F(3,0), then F(2,1), then F(1,2), then F(0,3). In a similar manner, the zig-zag scanning algorithm may scan the remaining diagonals of the DCT coefficient array 210. Accordingly, the zig-zag scan may finish by scanning F(7,6), then F(6,7), then F(7,7).

The result of the scan may then be 20 zeros, the coefficient of 2 at F(0,5), 13 zeros, the coefficient of 5 at F(1,6), and 29 zeros. This encoding method may indicate the number of zeros in a sequence and the coefficient value. For example, if *N indicates N number of zeros, the zig-zag scan result of the DCT coefficient array 210 may be (*20, 2, *13, 5, EOB). Since there is no non-zero coefficient after F(1,6), the EOB symbol may indicate to a decoding entity to pad a regenerated DCT coefficient array with zeros for the remainder of the array.

FIG. 2C is an exemplary diagram illustrating alternate scan of a pixel block, which may be utilized in connection with an embodiment of the invention. Referring to FIG. 2C there is shown there is shown an 8×8 DCT coefficient array 220 where F(0,5) has a coefficient value of 2 and F(1,6) has a coefficient value of 5. The remaining coefficients may be zeros. Alternate scanning of the coefficients in the DCT coefficient array 220 may scan F(0,0), then F(0,1), then F(0,2), then F(0,3). The next coefficients scanned may be F(1,0), then F(1,1), then F(2,0), then F(2,1), then F(1,2), then F(1,3). The next coefficients scanned may be F(0,4), then F(0,5), then F(0,6), then F(0,7).

The next coefficients scanned may be F(1,7), then F(1,6), then F(1,5), then F(1,4). The next coefficients scanned may be F(2,3), then F(2,2), then F(3,0), then F(3,1), then F(4,0). The next coefficients scanned may be F(4,1), then F(3,2), then F(3,3), then F(2,4), then F(2,5), then F(2,6), then F(2,7). The next coefficients scanned may be F(3,4), then F(3,5), then F(3,6), then F(3,7). The next coefficients scanned may be F(4,2), then F(4,3), then F(5,0), then F(5,1), then F(6,0), then F(6,1), then F(5,2), then F(5,3).

The next coefficients scanned may be F(4,4), then F(4,5), then F(4,6), then F(4,7), then F(5,4), then F(5,5), then F(5,6), then F(5,7). The next coefficients scanned may be F(6,2), then F(6,3), then F(7,0), then F(7,1), then F(7,2), then F(7,3). The final coefficients scanned may be F(6,4), then F(6,5), then F(6,6), then F(6,7), then F(7,4), then F(7,5), then F(7,6), then F(7,7).

The result of the scan may then be 11 zeros, the coefficient of 2 at F(0,5), 3 zeros, the coefficient of 5 at F(1,6), and 48 zeros. This encoding method may indicate the number of zeros in a sequence and the coefficient value. For example, if *N indicates N number of zeros, the alternate scan result of the DCT coefficient array 220 may be (*11, 2, *3, 5, EOB). Since there is no non-zero coefficient after F(1,6), the EOB symbol may indicate to a decoding entity to pad a regenerated DCT coefficient array with zeros for the remainder of the array.

Comparing the encoding of the DCT coefficient array 210 with the DCT coefficient array 220, it can be seen that the alternate scan of the DCT coefficient array 220 results in smaller numbers of zeros than the zig-zag scan of the DCT coefficient array 210. In instances where variable run-length encoding may be used for the numbers, using alternate scan may result in a more efficient encoding of a DCT coefficient array than using a zig-zag scan. Similarly, for other DCT coefficient arrays, using a zig-zag scan may result in more efficient encoding of a DCT coefficient array than using alternate scans.

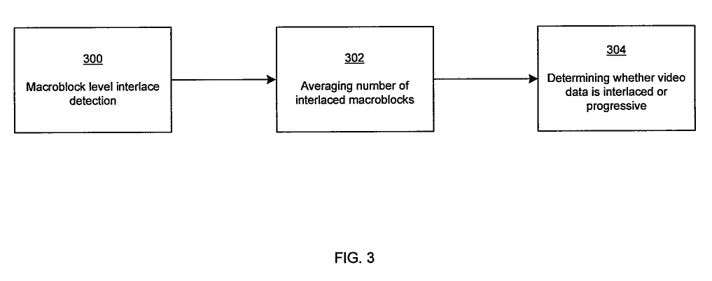

Video data may be interlaced or progressive. Zig-zag scan may be better suited for progressive video data and alternate scan may be better suited for interlaced data, for example. In that case, a frame by frame detection of whether the video data may be interlaced or progressive may be made to determine the scan algorithm to use for each frame. Accordingly, various embodiments of the invention may detect whether frames of video data may be interlaced or progressive and may switch scanning methods depending on whether the video data is an interlaced type or progressive type. This is discussed with respect to FIGS. 3-5.

FIG. 3 is an exemplary flow diagram for determining whether video data is interlaced or progressive, in accordance with an embodiment of the invention. Referring to FIG. 3, there is shown steps 300 to 304. In the step 300, a determination may be made of whether each macroblock may be interlaced or progressive video data. The macroblock may comprise, for example, a block of 16 pixels by 16 pixels. Frame variance and field variance may be calculated for each macroblock using, for example, the original unencoded picture. A variance may indicate smoothness of a pixel area. Therefore, smaller variance may indicate that the pixel area may be smooth and that the pixels may be correlated. For example, in an interlaced movie, odd fields and even fields may be snapshots of an event at different instances of time. Therefore, each field may be smoother individually than when the two fields are combined. Therefore, an interlaced video data may have a smaller field variance than frame variance.

Accordingly, the field variance may be subtracted from the frame variance. If the difference is, for example, greater than a threshold value, the macroblock may be considered to be an interlaced macroblock. Otherwise, the macroblock may be considered to be a progressive macroblock.

In step 302, the result for each macroblock may be accumulated to determine whether a frame or a plurality of frames may be interlaced or progressive. This may be because the quantity of macroblocks in a frame may fluctuate due to noise. However, video data that may have been pulled-up may erroneously weight the number of interlaced macroblocks. For example, for 3-2 pull-up, the two frames that have been pulled-up may comprise pull-up artifacts. A frame with pull-up artifacts may comprise a large number of interlaced macroblocks although the frame may be progressive. This may bias the determination of whether the video data is progressive type or interlaced type.

A pull-up detector (not shown) may be used before the progressive/interlace detector (not shown) and therefore the pulled-up content may be pulled-down and detected as progressive content. However, the pull-up detector may have some mismatches for a short time and bias the decision of the progressive/interlace detector. In order to alleviate the effects of these mismatches, the exemplary algorithm illustrated in FIG. 3 may be used.

Accordingly, an embodiment of the invention may use an algorithm where one frame from a cluster of, for example, 4 frames may be used to determine the number of interlaced macroblocks. For example, the number of interlaced macroblocks from each frame in the cluster may be compared, and the smallest number of interlaced macroblocks may be selected. The selected number of interlaced macroblocks may then be added to a running sum for, for example, 15 clusters or a macrocluster. The running sum may be cleared to zero at the end of the 15th cluster. Therefore, a running sum of interlaced macroblocks may be generated every 60 frames to determine whether the video data may be interlaced or progressive.

In step 304, the running sum may be compared to a progressive threshold and to an interlaced threshold, where the interlaced threshold may be a higher value than the interlaced threshold. The different values of the threshold may provide a hysteresis effect. If the running sum is lower than the progressive threshold, the video data may be considered to be progressive. Similarly, if the running sum is higher than the interlaced threshold, the video data may be considered to be interlaced. However, in order to reduce effects of noise on the video data, a plurality of consecutive running sums may need to be determined to be the same type of video data. For example, three consecutive running sums may need to indicate the same video data type before the video data is determined to be that video type.

When video data has been determined to be progressive type video data, an embodiment of the invention may also identify whether the video data may be top-field first cadence or bottom-field first cadence. By identifying the progressive cadence, the encoding of the video data may be more efficient. The identification of the progressive cadence may be by a method that may be design dependent.

Various embodiments of the invention may allow dynamic switching of scanning method from zig-zag scan to alternate scan, or vice-versa, depending on the video data. The processing described in the steps 300 to 304 may be accomplished by, for example, the image processor 112, the processor 114, and/or other circuitry, such as, for example, the logic block 118, which may be part of the video system 100.

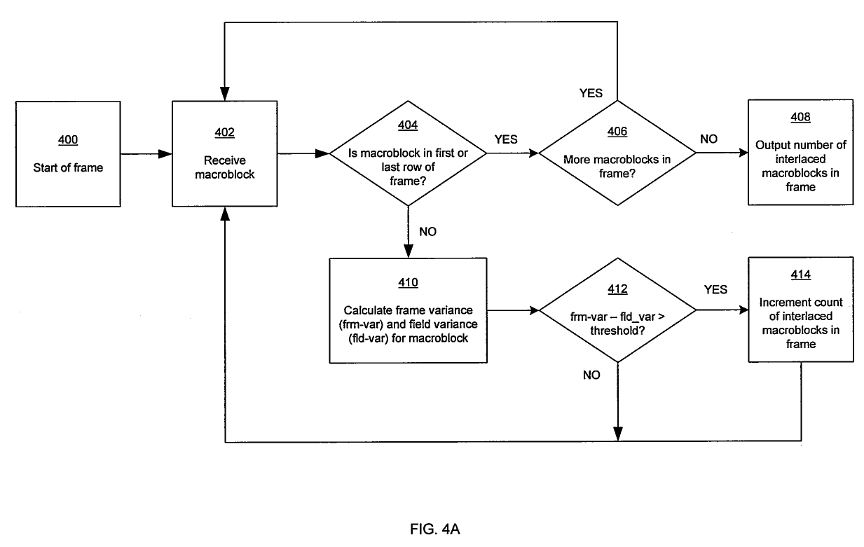

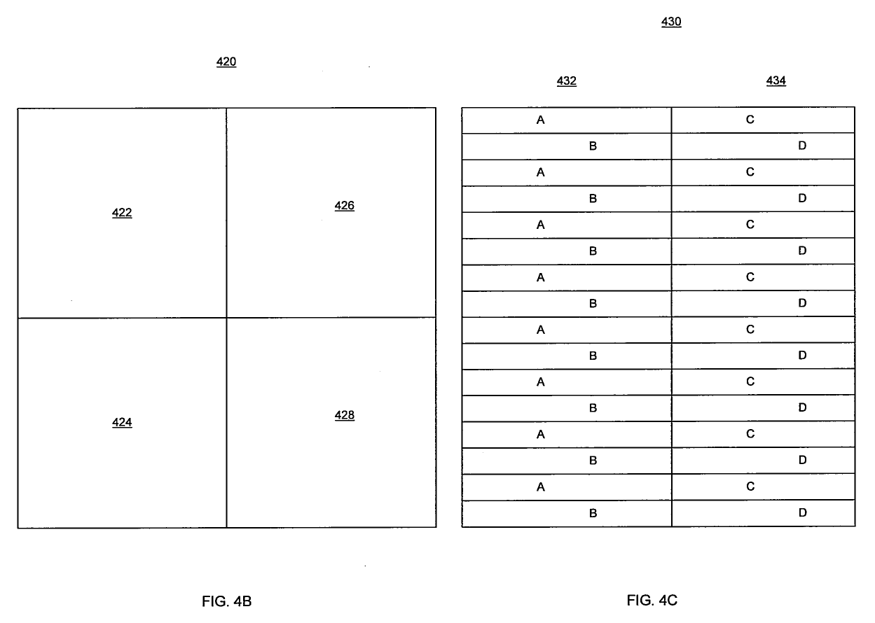

FIG. 4A is an exemplary flow diagram for determining whether macroblock of video data is interlaced or progressive, in accordance with an embodiment of the invention. Referring to FIG. 4A, there is shown steps 400 to 414. These steps may be at least a part of the processing described with respect to step 300. In step 400, a start of frame of video data may be detected. Accordingly, the number of interlaced macroblocks may be reset to zero. In step 402, a macroblock from the video data may be received. In step 404, a determination may be made of whether the received macroblock may be in the first row or last row of the frame. If the macroblock is from the first row or the last row of the frame, the macroblock may be discarded. This may be, for example, to filter transition from the edge, where the content may be black, to the content of the frame. If the macroblock is from the first row or the last row, the next step may be step 406. Otherwise, the next step may be step 410.

In step 406, a determination may be made as to whether there may be more macroblocks in the frame of video data. If more macroblocks are in the frame of the video data, the next step may be step 402. Otherwise, the next step may be step 408. In step 408, the total number of interlaced macroblocks in the frame may be communicated, for example, to the step 302.

In step 410, the frame variance and field variance for the macroblock may be calculated using pixels from the original unencoded picture. The process of handling the pixels in the macroblock for calculating the variances is discussed in more detail with respect to FIGS. 4B and 4C. In step 412, the field variance may be subtracted from the frame variance. If the difference is greater than a threshold, the macroblock may be considered to be an interlaced macroblock, and the next step may be step 414. Otherwise, the next step may be step 402. In step 414, the number of interlaced macroblocks may be incremented. The next step may be step 402.

FIG. 4B is an exemplary diagram illustrating a macroblock of video data for calculating frame variance, in accordance with an embodiment of the invention. Referring to FIG. 4B, there is shown a macroblock 420 that may comprise, for example, a 2-dimensional block of 16 pixels by 16 pixels. The macroblock may comprise, for example, four blocks 422, 424, 426, and 428, where each of the four blocks may comprise a 2-dimensional block of 8 pixels by 8 pixels. The frame variance for the macroblock 420 may be calculated by adding the individual variances for the blocks 422, 424, 426, and 428. The specific method of calculating variances for a block of pixels may be design dependent. Since the variance calculations are performed on the original unencoded pixel values, and not the DCT coefficients, the variance statistics may not be affected by quantization errors.

FIG. 4C is an exemplary diagram illustrating a macroblock of video data for calculating field variance, in accordance with an embodiment of the invention. Referring to FIG. 4C, there is shown a macroblock 430 that may comprise, for example, a 2-dimensional block of 8 pixels by 16 pixels. The macroblock may comprise, for example, two blocks 432 and 434. Each of the blocks 432 and 434 may comprise rows of eight pixels. For example, the block 432 may comprise rows of eight pixels that belong to a group of pixels that may be referred to as A alternating with rows of eight pixels that belong to a group of pixels that may be referred to as B.

Similarly, the block 434 may comprise rows of eight pixels that may belong to a group of pixels that may be referred to as C alternating with rows of eight pixels that may belong to a group of pixels that may be referred to as D. The field variance for the macroblock 430 may be calculated by adding the individual variances for the pixel rows A, the pixel rows B, the pixel rows C, and the pixel rows D. The specific method of calculating variances for a block of pixels may be design dependent. Since the variance calculations may be performed on the original unencoded pixel values, and not the DCT coefficients, the variance statistics may not be affected by quantization errors.

FIG. 5 is an exemplary flow diagram for calculating an appropriate number of interlaced video blocks in a determined number of frames, in accordance with an embodiment of the invention. Referring to FIG. 5, there is shown steps 500 to 508. These steps may be at least a part of the processing described with respect to step 302. In step 500, a number of interlaced macroblocks in a frame may be received. If the number of interlaced macroblocks is for a first frame of the 4-frame cluster, the number of interlaced macroblocks associated with a cluster may be cleared to zero.

In step 502, the number of interlaced macroblocks associated with a cluster may be compared with the received number of interlaced macroblocks. The number of interlaced macroblocks associated with a cluster may be replaced with the received number of interlaced macroblocks if the received number of interlaced macroblocks is smaller than the number of interlaced macroblocks associated with a cluster. This may be continued until the number of interlaced macroblocks may have been received for all four frames in a cluster. Accordingly, the final value of the number of interlaced macroblocks associated with a cluster may be the smallest number of macroblocks for the four frames in the cluster.

In step 504, the number of interlaced macroblocks associated with a cluster may be added to the total number of interlaced macroblocks. If the cluster is the first cluster in a macrocluster, the total number of interlaced macroblocks may be cleared to zero before adding the number of interlaced macroblocks associated with the first cluster. In step 506, a determination may be made of whether the number of interlaced macroblocks for the 15 clusters of a macrocluster may have been processed. If so, the next step may be step 508. Otherwise, the next step may be step 500.

In step 508, the total number of interlaced macroblocks in the macrocluster, or 60 frames, may be output. Another embodiment of the invention may, for example, output an average number of the interlaced macroblocks. The average number may be, for example, for a cluster or for a frame. Accordingly, if the average number is per cluster, the total number of interlaced macroblocks in the macrocluster may be divided by 15. If the average number is per frame, the total number of interlaced macroblocks in the macrocluster may be divided by 60.

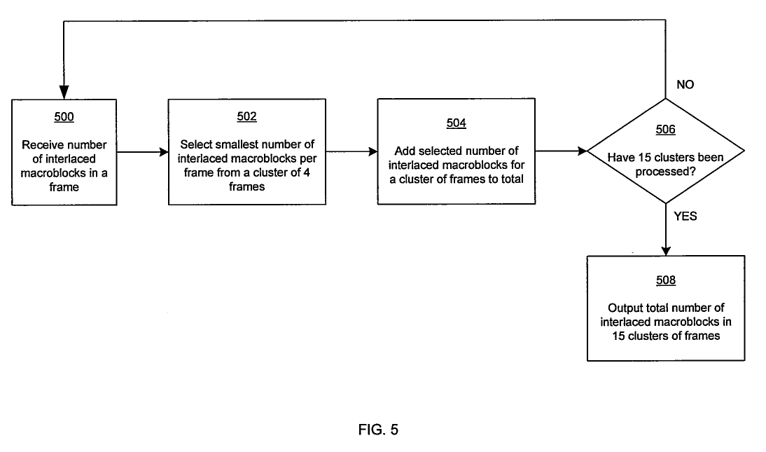

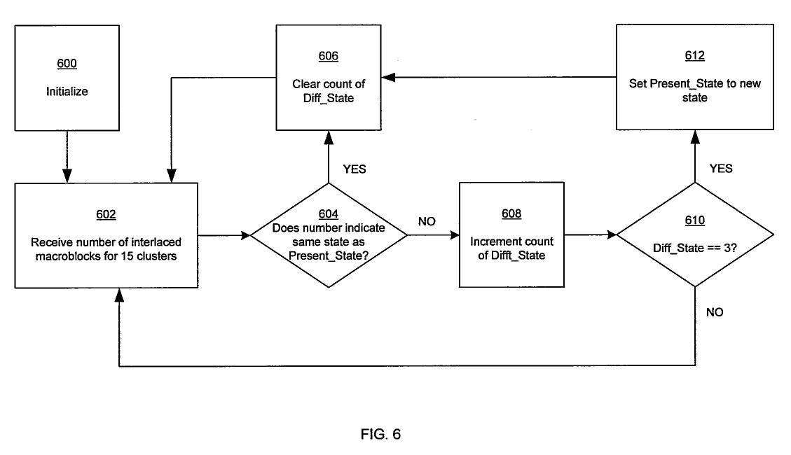

FIG. 6 is an exemplary flow diagram for determining whether video data is interlaced or progressive, in accordance with an embodiment of the invention. Referring to FIG. 6, there is shown steps 600 to 612. In step 600, suitable logic, circuitry, and/or code that may be used for determining whether the video data is interlaced or progressive may be initialized. The determination may be made by, for example, the image processor 112, the processor 114, and/or other circuitry, such as, for example, the logic block 118, which may be part of the video system 100. The initialization may comprise, for example, setting the video state to interlaced or progressive for a default state. This may be referred to as a Present_State, for example. The initialization may also comprise, for example, clearing a counter that keeps count of the number of interlaced macroblocks in a macrocluster. In step 602, the number of macroblocks in a macrocluster may be received.

In step 604, the number of macroblocks in a macrocluster may be compared to two threshold numbers, a progressive data threshold number and an interlaced data threshold number. In instances where the number of macroblocks in a macrocluster may be greater than the interlaced data threshold number, a new state of the video data may be considered to be interlaced video data. In instances where the number of macroblocks in a macrocluster may be less than the progressive data threshold number, the new state of the video data may be considered to be progressive video data. The two thresholds may be different numbers. Accordingly, hysteresis may be used to reduce transient effects due to noise. Additionally, the state of video data may be determined to be different from the Present_State, for example, three consecutive times before the Present_State may be changed to the different state. This may also reduce noise susceptibility, for example. The count of successive determinations may be referred to as, for example, Diff_State.

If the new state of the video data is different from the Present_State of the video data, the next step may be step 608. Otherwise, the next step may be step 606. In step 606, since the Present_State of the video data may be the same as the most recently determined state of the video data, the next step may be step 602. If Diff_State is non-zero, then it may be cleared to zero. In step 608, since the new state of the video data is different from the Present_State, the value in Diff_State may be incremented by one. In step 610, if the Diff_State is equal to three, the next step may be step 612. Otherwise, the next step may be step 602.

In step 612, Present_State may be set to the new state. For example, if the Present_State indicated that the video data was interlaced video data, then Present_State may be set to indicate that the video data is now considered to be progressive video data. Similarly, if the Present_State indicated that the video data was progressive video data, then Present_State may be set to indicate that the video data is now considered to be interlaced video data. The next step may be step 606 where the value in Diff_State may be cleared to zero. The next step may be step 602.

In accordance with an embodiment of the invention, aspects of an exemplary system may comprise a video processing circuitry, such as, for example, the image processor 112, the processor 114, and the logic block 118 in the video system 100. The video system 100 may be, for example, a set-top box, a personal computer, a mobile terminal, a television set, and/or other electronic devices that may process video data. The video system 100 may adaptively change an encoding algorithm for video data based on the type of video data. The video data may be, for example, interlaced video data or progressive video data.

The video system 100 may encode at least a portion of the video data using a zigzag scan for the encoding algorithm when the video data is progressive data. Similarly, the video system 100 may encode at least a portion of the video data using alternate scan for the encoding algorithm when the video data is interlaced data. The video system 100 may also determine a top-field first cadence or a bottom-field first cadence for encoding the video data when the video data is determined to be progressive data.

The video system 100 may also determine, for example, whether a macroblock is an interlaced macroblock. A macroblock may comprise, for example, a block of 16 pixels by 16 pixels. The video system 100 may, for example, determine a frame variance and a field variance for each macroblock using pixels from the original unencoded picture. The field variance may be subtracted from the frame variance for each macroblock, and the result may be compared to a threshold value. If the difference is greater than the threshold value, the macroblock may be considered to be an interlaced macroblock. Otherwise, the macroblock may be considered to be a progressive macroblock. The threshold value may be design and/or implementation dependent.

The video system 100 may then be able to count a number of interlaced macroblocks in each frame in a cluster of frames. There may be, for example, four frames in a cluster. The video system 100 may also determine a number of the interlaced macroblocks that corresponds to a cluster by, for example, selecting the smallest number of the interlaced macroblocks for each of the frames in the cluster.

The video system 100 may then add the number of interlaced macroblocks corresponding to each cluster of a macrocluster, where a macrocluster may comprise, for example, 15 clusters. The total number of interlaced macroblocks in a macrocluster may be used to determine whether the received video data may be formatted as interlaced scan video data or progressive scan video data. The video system 100 may then compare the number of interlaced macroblocks to an interlaced data threshold number and/or a progressive data threshold number, where the interlaced data threshold number may be different from the progressive data threshold number.

In instances where the number of interlaced macroblocks may be greater than the interlaced data threshold number, the video data may be temporarily considered to be interlaced video data. In instances where the number of interlaced macroblocks may be less than the progressive data threshold number, the video data may be temporarily considered to be progressive type video data. In instances where a determination of data type, for example, interlaced type, may be the same, for example, for three successive macroclusters, the video data may be considered to be interlaced type video data. Accordingly, the appropriate scan method may be used for interlaced type video data. Similarly, in instances where a determination of data type, for example, progressive type video data, may be the same for three successive macroclusters, the video data may be considered to be progressive type video data. Accordingly, the appropriate scan method may be used for progressive type video data.

While various embodiments of the invention may have been discussed defining a cluster as comprising four frames, and a macrocluster as comprising fifteen clusters, the invention need not be so limited. The cluster may comprise a plurality of frames other than four, and a macrocluster may comprise a plurality of clusters other than fifteen. Similarly, various embodiments of the invention may have described detecting interlaced macroblocks. However, the invention need not be so limited. For example, other embodiments of the invention may detect progressive macroblocks. Additionally, various embodiments of the invention may allow the progressive data threshold number to be the same as the interlaced data threshold number. Various embodiments of the invention may also allow a number of successive data type determinations to be other than three.

Another embodiment of the invention may provide a machine-readable storage, having stored thereon, a computer program having at least one code section executable by a machine, thereby causing the machine to perform the steps as described above for MPEG2 progressive/interlace type detection.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for data processing, the method comprising:
adaptively changing an encoding algorithm used to encode video data based on a detected type of said video data.

2. The method according to claim 1, wherein said detected type of said video data is one of: interlaced type and progressive type.

3. The method according to claim 2, comprising encoding at least a portion of said video data using zigzag scan for said encoding algorithm when said detected type of said video data is said progressive type.

4. The method according to claim 2, comprising encoding at least a portion of said video data using alternate scan for said encoding algorithm when said detected type of said video data is said interlaced type.

5. The method according to claim 2, comprising determining a cadence for encoding said video data when said type of said video data is said progressive type.

6. The method according to claim 5, wherein said determined cadence is one of: top-field first cadence and bottom-field first cadence.

7. The method according to claim 2, comprising:
determining a number of interlaced macroblocks in each frame in a cluster of frames of said video data;
determining a number of said interlaced macroblocks corresponding to a cluster in a macrocluster of clusters based on said number of interlaced macroblocks in each frame of said cluster of frames; and
determining, based on said number of said interlaced macroblocks corresponding to said macrocluster of clusters, whether said video data is said interlaced type or said progressive type.

8. The method according to claim 7, wherein said interlaced macroblock is a macroblock whose frame variance, calculated over the original unencoded picture, minus a field variance, calculated over the original unencoded picture, is greater than a determined threshold value.

9. The method according to claim 7, comprising calculating said number of said interlaced macroblocks corresponding to said cluster by selecting a smallest number from among said determined numbers of said interlaced macroblocks in said each frame of said cluster of frames.

10. The method according to claim 9, comprising calculating a macrocluster number of said interlaced macroblocks by adding said number of said interlaced macroblocks corresponding to said cluster for each cluster in a macrocluster.

11. The method according to claim 10, wherein said video data comprises said interlaced video data when a plurality of sequential macroclusters are determined to be said interlaced video data.

12. The method according to claim 10, wherein said video data comprises said progressive video data when a plurality of sequential macroclusters are determined to be said progressive video data.

13. The method according to claim 10, wherein said macrocluster comprises interlaced video data when said macrocluster number is greater than an interlaced data threshold number.

14. The method according to claim 10, wherein said macrocluster comprises progressive video data when said macrocluster number is less than a progressive data threshold number.

15. A system for data processing, the system comprising:
one or more circuits that enables adaptively changing an encoding algorithm used to encode video data based on a detected type of said video data.

16. The system according to claim 15, wherein said detected type of said video data is one of: interlaced type and progressive type.

17. The system according to claim 16, wherein said one or more circuits enables encoding of at least a portion of said video data using zigzag scan for said encoding algorithm when said detected type of said video data is said progressive type.

18. The system according to claim 16, wherein said one or more circuits enables encoding of at least a portion of said video data using alternate scan for said encoding algorithm when said detected type of said video data is said interlaced type.

19. The system according to claim 16, wherein said one or more circuits enables determination of a cadence for encoding said video data when said type of said video data is said progressive type.

20. The system according to claim 19, wherein said determined cadence is one of: top-field first cadence and bottom-field first cadence.

21. The system according to claim 16, wherein said one or more circuits bases said detected type on:
determining a number of interlaced macroblocks in each frame in a cluster of frames of said video data;
determining a number of said interlaced macroblocks corresponding to a cluster in a macrocluster of clusters based on said number of said interlaced macroblocks in each frame of said cluster of frames; and
determining whether said video data is said interlaced type or said progressive type, based on said number of interlaced macroblocks corresponding to said macrocluster of clusters.

22. The system according to claim 21, wherein said interlaced macroblock is a macroblock whose frame variance, calculated over an original unencoded picture, minus a field variance, calculated over said original unencoded picture, is greater than a determined threshold value

23. The system according to claim 21, wherein said one or more circuits enables calculation of said number of said interlaced macroblocks corresponding to said cluster by selecting a smallest number from among said determined numbers of said interlaced macroblocks in said each frame of said cluster of frames.

24. The system according to claim 23, wherein said one or more circuits enables calculation of a macrocluster number of said interlaced macroblocks by adding said number of said interlaced macroblocks corresponding to said cluster for each cluster in a macrocluster.

25. The system according to claim 24, wherein said video data comprises said interlaced video data when a plurality of sequential macroclusters are determined to be said interlaced video data.

26. The system according to claim 24, wherein said video data comprises said progressive video data when a plurality of sequential macroclusters are determined to be said progressive video data.

27. The system according to claim 24, wherein said macrocluster comprises interlaced video data when said macrocluster number is greater than an interlaced data threshold number.

28. The system according to claim 24, wherein said macrocluster comprises progressive video data when said macrocluster number is less than a progressive data threshold number.
